(19) United States
(12) Patent Application Publication
(10) Pub. No.: US 2014/0231451 A1
(43) Pub. Date: Aug. 21, 2014

(54) TEMPORARY LIQUID SOAP OR SANITIZER SUPPORT STRUCTURES AND DISPENSER SYSTEMS

(71) Applicants: Ronald J. Hammond, Bentleyville, OH (US); Andrew J. White, Akron, OH (US); Bradley T. Schellhase, Broadview Heights, OH (US); Doug Zlatic, North Royalton, OH (US); Matthew Archer, Aurora, OH (US); Carl W. Peterson, Clinton, OH (US)

(72) Inventors: Ronald J. Hammond, Bentleyville, OH (US); Andrew J. White, Akron, OH (US); Bradley T. Schellhase, Broadview Heights, OH (US); Doug Zlatic, North Royalton, OH (US); Matthew Archer, Aurora, OH (US); Carl W. Peterson, Clinton, OH (US)

(73) Assignee: GOJO Industries, Inc., Akron, OH (US)

(21) Appl. No.: 13/768,190

(22) Filed: Feb. 15, 2013

(51) Int. Cl. B65D 35/56; B67D 99/00

(52) U.S. Cl. CPC B31F 7/00; B67D 99/00
USPC 222/105; 222/173; 493/356

(57) ABSTRACT

Temporary support structures for holding fluid dispensing systems and removable refill units are disclosed herein. The temporary support structures are formed out of flat stock that is cut into desired shapes and has predetermined fold lines. The flat stock may be folded along the predetermined fold lines and assembled into a temporary support structure that includes a base and a tower.

### TECHNICAL FIELD

The present invention relates generally to temporary liquid soap or sanitizer dispenser support structures and systems, and methods for providing such temporary support structures and dispenser systems in the event of an emergency situation, a pandemic, a large public gathering or the like.

### BACKGROUND OF THE INVENTION

Liquid soap or sanitizer dispensers provide a user with an amount of liquid soap or sanitizer upon actuation of the dispenser. The terms “soap” or “sanitizer,” as defined herein, mean any skincare product, and representative examples include soaps, sanitizers, moisturizers, cleansers and disinfectants. Permanent liquid soap or sanitizer dispensers are well-known and may often be found in public restrooms and other public places. These known permanent liquid soap or sanitizer dispensers comprise a permanent outer enclosure, a supply of liquid soap or sanitizer contained within the permanent outer enclosure and a dispensing mechanism for dispensing the liquid soap or sanitizer to a user. The permanent outer enclosure is typically formed from a durable and long-lasting material, such as plastic or metal.

From time to time, the liquid soap or sanitizer supply held within a permanent liquid soap or sanitizer dispenser will become depleted or otherwise need to be replenished. In general, there are two methods for refilling the liquid supply within a dispenser. First, the liquid may be held in a reservoir formed within the outer enclosure which can be accessed so that additional liquid may be poured or otherwise injected into the reservoir. Second, and much more popular in modern liquid dispenser systems, the liquid supply is stored within a separate removable refill unit held within the outer enclosure. Empty refill units are then removed and replaced with full refill units, as needed. Removable liquid refill units may be flexible bag-like structures, rigid box-like structures, rigid but collapsible structures or have some other configuration with a pump and outlet secured thereto. These more modern liquid dispenser systems are generally preferred because they are easier to refill, they decrease the likelihood of spills and they are more hygienic in comparison with the older pouring the liquid in a reservoir approach.

Known liquid dispensers are permanent, meaning such dispensers are intended to have a useful life of several years. These dispensers, however, are complex, require many parts and have a relatively long lead time during high demand periods, such as, during times of pandemics, such as, for example, the swine flu pandemic that occurred a few years ago. In addition, it is not practical to install permanent dispensers in locations that temporarily host events, such as carnivals, community fairs, concerts and the like.

It would be desirable to provide a temporary liquid dispenser system that can be mass produced and distributed in short order to battle pandemic conditions, even if these systems have a useful life of only several weeks or several months, or for temporary events. The present invention is directed to such a temporary dispenser system.

### SUMMARY

A temporary dispenser system is provided herein. In one embodiment, the system comprises a temporary support structure, a removable liquid container supported by the temporary support structure and holding a supply of liquid to be dispensed by the system, and a pump and outlet fluidically attached to the removable liquid container in order to dispense a supply of liquid or foam upon actuation.

The temporary soap or sanitizer support structures and dispenser systems disclosed herein are particularly useful for use in public emergency situations. Examples of such situations include pandemics, large fires such as forest fires, earthquakes, floods and the like. Or for temporary events, such as carnivals, community fairs, concerts and the like. In these situations, a large number of temporary fluid dispenser systems may be deployed in kit form with a minimum amount of effort and at a low cost in order to help ensure public hygiene during such situations.

Exemplary temporary support structures for holding fluid dispensing mechanisms and/or refill units are disclosed herein. Some exemplary temporary support structures have one or more flat panels which form a temporary support structure by being folded or attached to one another. The temporary support structure includes a base for supporting the temporary structure in an upright position; a holder for receiving a removable refill unit that holds a supply of liquid to be dispensed by the system, and an upright section extending from the base to the holder.

Another exemplary temporary support structure for holding fluid dispensing mechanisms and/or refill units includes a first flat panel in a flattened condition. The first flat panel includes cut lines and fold lines. The first flat panel may be folded into the shape of a base. The temporary support structure includes a second flat panel in a flattened condition. The second flat panel has cut lines and fold lines. The second flat panel may be folded into a shape of a tower and secured to the base. The tower includes a holder for holding a fluid dispense mechanism to dispense fluid onto an object.

Exemplary methodologies of creating a temporary support structure for holding fluid dispensing mechanisms and/or refill units are also provided. One exemplary method of providing a temporary support structure for a dispensing system includes cutting one or more flat panels into desired shapes and creating predetermined fold lines in the one or more cut flat panels. Wherein cutting the flat panels into desired shapes includes cutting the flat panel so that at least one flat panel will form a holder for holding a refill unit or a dispenser. The methodology also includes cutting the flat panels so that at least one flat panel will form a base for supporting the temporary support structure on a floor, and cutting the flat panel so that at least one flat panel will form an intermediate portion between the base and the holder.

### BRIEF DESCRIPTION OF THE DRAWINGS

These and other features and advantages of the present invention will become better understood with regard to the following description and accompanying drawings in which:

FIGS. 1 and 2 are different perspective views of a first exemplary temporary soap or sanitizer dispensing system;

FIG. 1A illustrates an exemplary refill unit;

FIG. 3 is top view of the first exemplary temporary soap or sanitizer dispensing system, with an access panel in an open position;

FIG. 4 is a partial front view of a second exemplary temporary soap or sanitizer dispensing system;

FIG. 5 is a partial front view of a third exemplary temporary soap or sanitizer dispensing system;

FIG. 6 illustrates an exemplary view of a base in a knocked-down state for a temporary soap or sanitizer dispensing system;

FIG. 7 illustrates an exemplary view of a tower in a knocked-down state for a temporary soap or sanitizer dispensing system; and

FIG. 8 illustrates an exemplary view of an insert for the tower in a knocked-down state for a temporary soap or sanitizer dispensing system.

### DETAILED DESCRIPTION

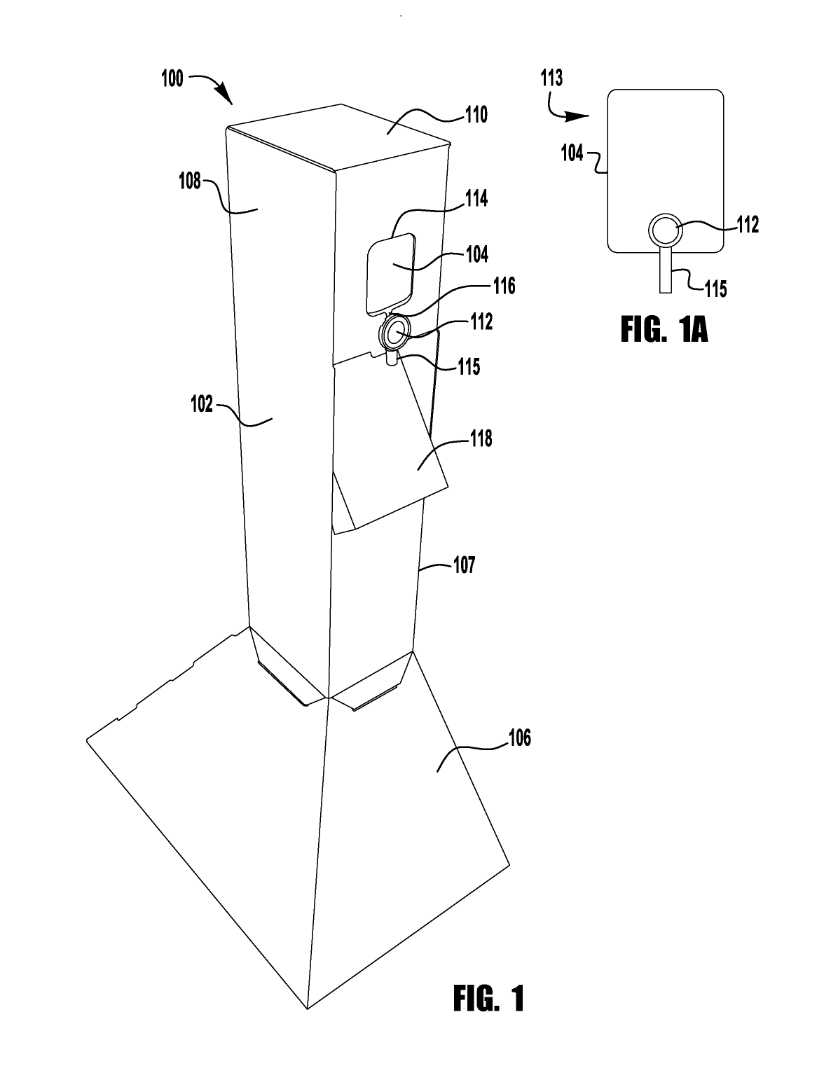

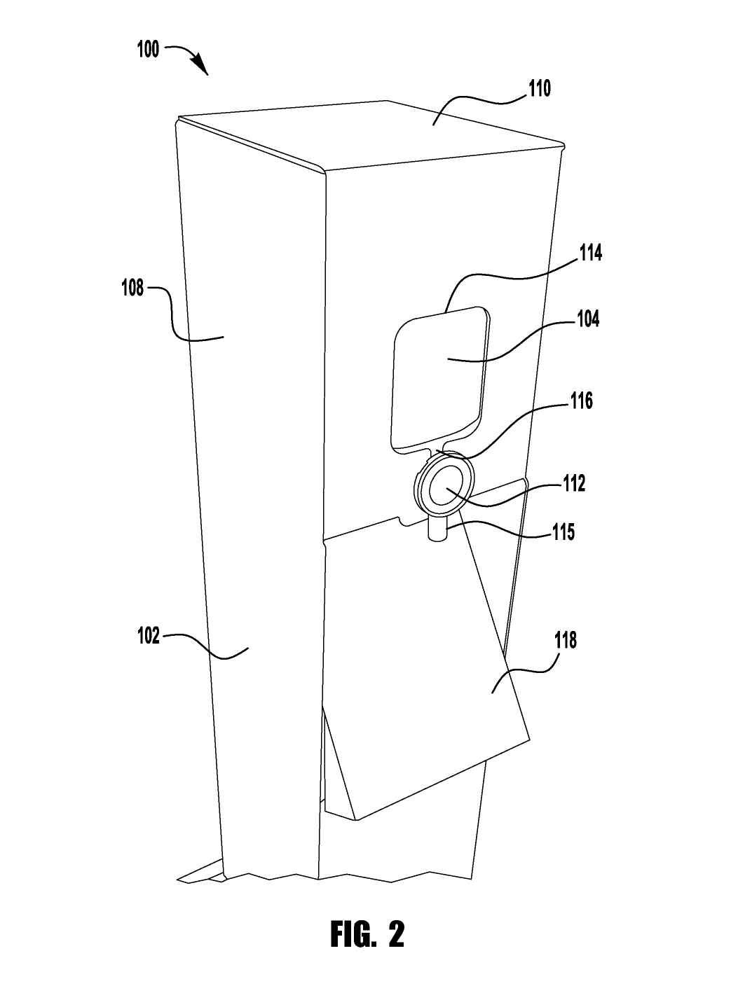

FIGS. 1 through 3 illustrate a first exemplary embodiment of a temporary liquid dispenser system 100. The illustrated system 100 comprises a temporary support structure 102 and a removable liquid container 104 which holds a supply of liquid soap or sanitizer to be dispensed by the system 100. The support structure 102 is preferably made from a material which is lightweight but yet suitably durable to support the liquid container 104 over an expected lifetime of several weeks or several months. It is also preferred to utilize environmentally friendly materials which are easily disposable. Thus, depending on the environment involved, suitable materials may include craft board, cardboard, plastics formed as a corrugated board, which may be recyclable, and the like.

In particularly preferred embodiments, the temporary support structure 102 comprises one or more flat or essentially two-dimensional panels which are folded and attached to one another to form the three-dimensional structure 102. In some embodiments, the attaching of the various flat panels is advantageously accomplished without use of any additional elements separate from the panels themselves, such as staplers, glue, rivets, clips or the like. For example, the flat panels may attach to each other via mating tab in slot interactions or the like. Such embodiments are easily manufactured and may then be shipped to end-use customers in a knocked-down or flat state which greatly facilitates and reduces the cost of the shipping and storage process by minimizing the space required for storing the system before actual use.

Such embodiments also are easily erected by the end-use customers when it becomes time for them to be deployed on a temporary basis. In some embodiments, temporary support structure 102 is formed out of a flat piece of cardboard that is stamp cut and has fold lines that are pre-bent. A user simply folds along the fold lines to form a section and locks the section together with tabs. If the temporary support structure 102 is made of multiple sections, the sections may be locked together with tabs. In some embodiments, a user may use plastic clips, staples, glue or the like to lock the sections together or to strengthen a tab connected joint.

The illustrated temporary support structure 102 is in the form of a stand, such that the liquid container 104 may be easily accessed by a user in a standing position next to the stand. The support structure 102 has a base 106 and a tower 107. The base permits the support structure 102 to remain stable when placed on a supporting surface, such as a floor, in an outside or in an inside environment. In some embodiments, the base has a square footprint. In some embodiments, the base has a rectangular footprint. Various base footprint configurations may be provided to increase stability or to facilitate locating the temporary dispensers in certain locations, such as for example, against a wall or in a corner.

Additional, panel portions comprising extending flange elements (not shown) may alternatively or additionally be used to improve the upright stability of the standing support structure 102. In yet further embodiments, one or more ballast elements (not shown) may be placed within or around the base 106 in order to improve the stability of the overall system 100. Such ballast elements might include pouches filled with water or sand, or even one or more soap or sanitizer-filled containers 104 which may be used to replace the container 104 which is currently disposed in the top portion 108 of tower 107.

The top portion 108 of the support structure 102 houses the removable liquid container 104. As previously known, the container 104 may be a flexible bag-like structure, a rigid box-like structure, a collapsible rigid structure or have some other configuration. In order to refill the liquid soap or sanitizer supply of the system 100, the user needs only to remove the existing empty container 104 and replace it with a full container 104. In additional embodiments (not shown), the liquid may be directly held in a reservoir formed within a temporary liquid dispenser system 100, to be refilled by injecting more liquid into the reservoir.

Container 104 is connected to a dome pump 112 and outlet nozzle 115 to form a refill unit 113. Accordingly, when the container 104 is removed from the temporary support structure 102, the dome pump 112 and outlet nozzle 115 are also removed and replaced.

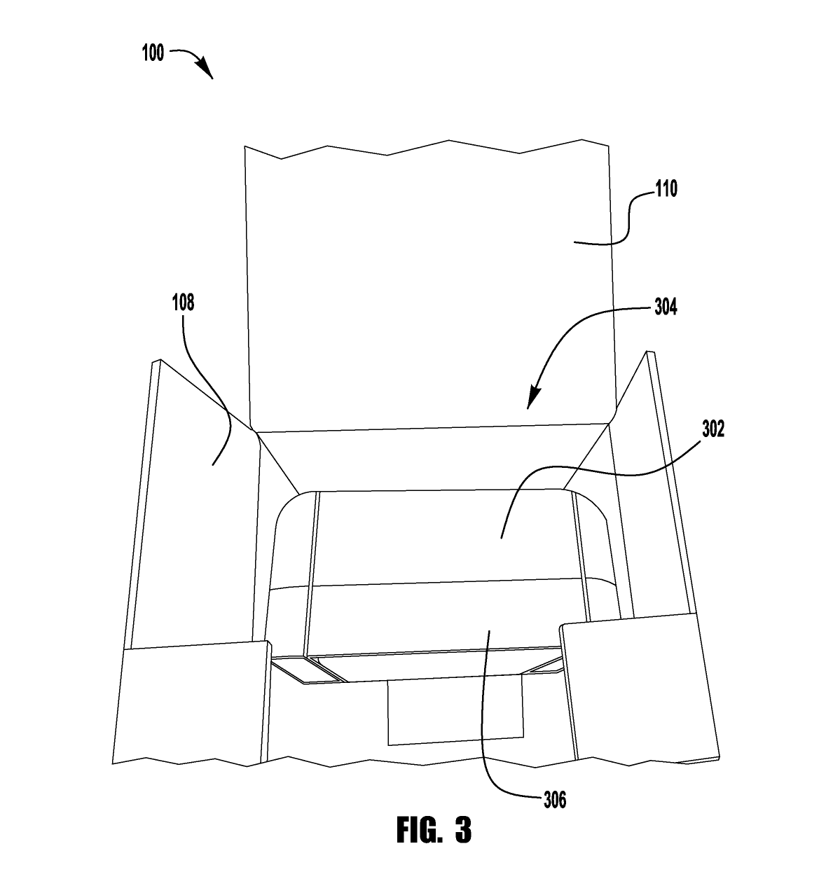

The top portion 108 of the support structure 102 has an access panel 110 which is normally in a closed position, as illustrated in FIG. 1. In that closed position, the access panel 110 and the rest of the surrounding top portion 108 of the support structure 102 help to prevent the container 104 from being punctured or otherwise compromised by foreign objects or removed by persons using the temporary dispenser system 100. The access panel 110 may be moved to an open position, as shown in FIG. 3, in order to remove and replace the liquid container 104 held within the support structure 102.

In the illustrated temporary dispenser system 100, a liquid dome pump 112 and outlet 115 are attached to and removable with the liquid container 104 in the form of a refill unit 113 (FIG. 1A). As each new refill unit 113 is inserted into the top portion 108 of the support structure 102, the refill unit 113 is oriented so that the liquid pump 112 and outlet 115 protrudes out of an aperture 114 in a front face of the support structure 102. The liquid pump 112 and outlet 115 enter into a slot portion 116 formed on the bottom of the aperture 114. In one embodiment, the liquid refill unit 113 is held in place within the support structure 102 by the interaction between the liquid dome pump 112 and the slot portion 116. In alternative embodiments, the refill unit 113 may alternatively or additionally be supported by other supporting elements of the support structure 102.

The container 104 may have printed information on a portion of the container 104 which is viewable by a user through the aperture 114 when installed in the support structure 102. The printed information may include instructions for using the system 100, a description of the chemical formulation of the liquid inside the container 104, governmental regulatory information and the like. In addition, aperture 114 allows a user or maintenance personnel to determine whether refill unit 113 is empty or needs to be replaced.

Any type of liquid dispenser may be used in connection with the temporary liquid dispensing systems disclosed herein. In the particular system 100 illustrated in FIG. 1, the liquid refill unit 113 has a manual push dome pump 112 type dispenser. That is, when a user depresses a push dome 112 on the refill unit 113, the refill unit 113 ejects an amount of liquid soap or sanitizer previously stored in the container 104 onto the user's hand underneath the outlet 115. The pump 112 may include finger wings (not shown) adjacent to the dome, to provide suitable leverage for the user to depress the dome without tipping over the support structure 102. One of ordinary skill in the art will know of many other kinds of manual liquid dispensers, including for example a manual lever, a manual pull bar, a manual push bar, a manual rotatable crank and the like.

Electrically-activated dispensers may also be used in connection with the temporary dispenser systems disclosed herein. In one such embodiment, an electric dispenser includes a motion detector to provide for a hands-free or “touchless” operation. Such electrically-activated dispensers require an electrical power source, like a battery or an external power source electrically connected to the liquid dispenser.

As illustrated in FIG. 3, off-the-shelf electrically-activated liquid or foam dispenser 302 may be used in the embodiments of the presently described invention and inserted into opening 304 at the top of the dispenser system. Off-the-shelf dispensers have a housing 306 surrounding the internal components.

Preferably, and optionally, a scaled down touch-free electronic dispenser (not shown) may be used. For example, an electronics package including a sensor for sensing an object, a processor, a battery for providing power and an actuator may be attached to a receptacle for receiving a refill unit and may be inserted into the opening 304 on the top of the dispenser system 100. The electronics package need not include an exterior housing because the components will be protected by the dispenser system 100. Thus, once the electronics package has been inserted into the opening 304, a refill unit (not shown) may simply be dropped through the opening 304 and into a receptacle for receiving a refill unit.

As already discussed above, in the particular temporary liquid soap or sanitizer dispenser system 100 of FIGS. 1 through 3, the manual push-dome pump 112 and outlet 115 are attached to and removable with the liquid container 104. In such embodiments, all of the liquid path, storage and delivery portions are formed as parts of a single module which is separate and removable from the support structure 102 in the form of a refill unit 113.

In other embodiments, a pumping portion of a liquid dispenser may instead be directly attached to and supported by the support structure and each time a new liquid container is installed into the support structure, the user fluidically connects the new container with the pumping portion of the liquid dispenser on the support structure. Optionally, the new container may be emptied or poured into a container secured to the pumping portion of the liquid dispenser.

The liquid dispenser portion of the liquid dispenser system 100 may contain one or more foaming elements therein to mix the liquid from the container 104 with air to form a foam for dispensing to a user. Suitable foaming elements include, for example, an air pump and one or more screens, meshes, porous membranes or sponges.

The illustrated temporary support structure 102 additionally includes a drip catch portion 118 disposed on the front face of the structure 102 underneath the liquid refill unit 113. The drip catch portion 118 catches fluid and/or foam which drips out of the liquid refill unit 113 after a dispensing action has been completed. The particular drip catch portion 118 in the illustrated system 100 is a inserted at an angle into the central area of the top portion 108, but other drip catch portion structures may be used. Although not shown in FIG. 1, the drip catch portion 118 may include a removable element formed of an easily cleaned material such as a thermoplastic material for removal of fluid caught by the drip catch portion 118.

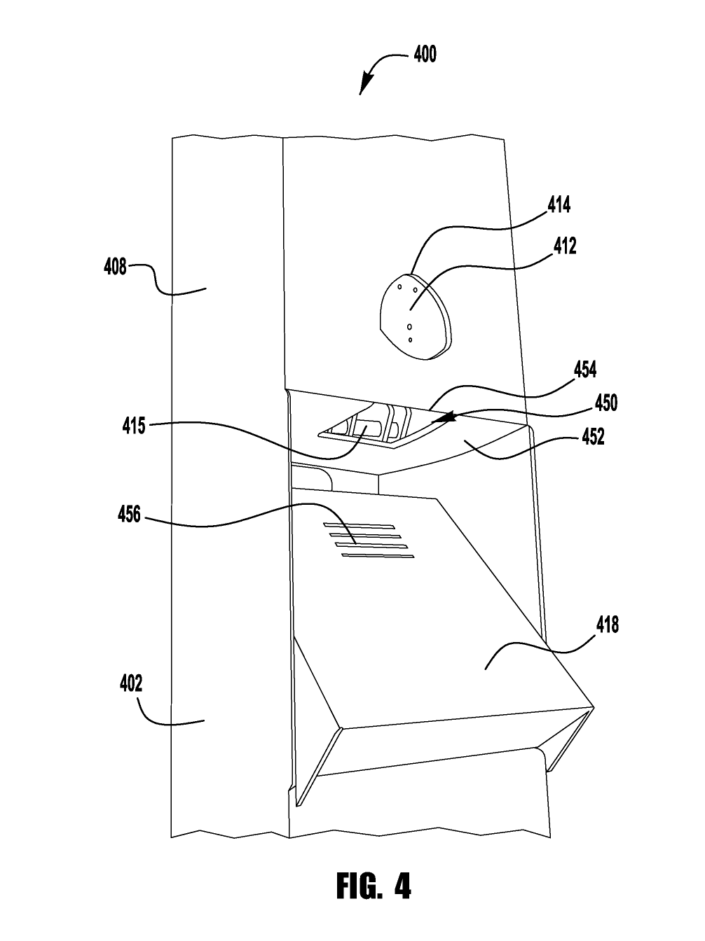

Another embodiment of a temporary liquid soap dispensing system 400 is illustrated in FIG. 4. The system 400 as shown FIG. 4 includes many of the same components as the system 100 described above in connection with FIGS. 1 through 3, which are similarly numbered. Thus, the system 400 has a temporary support structure 402 substantially identical to the temporary support structure 102 of the temporary dispenser system 100, including a top portion 408 for holding a liquid container (not shown in FIG. 4).

The system 400 of FIG. 4 also has a few additional features not shown in the system 100 of FIGS. 1 through 3, although some of these additional features may be used in connection with that system 100 as well. The fluid dispenser 412 of FIG. 4 is an electrically-operated touch-free fluid dispenser. When a touch-free dispenser, such as the dispenser 412 is used, in some cases the dispenser may be conveniently attached to the support structure.

In the particular system 400, the touch-free dispenser 412 has a hands-free activation. Thus, a sensor element 450 of the touch-free dispenser 412 is exposed by the aperture 454 in the top portion 408 of the support structure 402. A user waves his or her hand near the sensor element 450 in order to activate the touch-free dispenser 412.

FIG. 4 additionally illustrates a supporting element 452 which is provided by the support structure 402 in order to help support the touch-free dispenser 412 in the top portion 408 of the structure 402. The support structure 452 has an aperture 454 through which fluid is dispensed by the electrical liquid dispenser 412 when activated. During operation, touch-free dispenser 412 would be loaded from the top and the refill unit (not shown) would include a pump and outlet nozzle to be activated by actuator 415. The outlet nozzle (not shown) would extend through aperture 454.

The drip catch portion 418 illustrated in FIG. 4 has three slots 456 formed therein, disposed underneath the aperture 454 of the supporting structure 402. The drip catch portion 418 catches fluid and/or foam if it drips out of the electric touch-free dispenser 412 after a dispensing action has been completed. At least some of the caught fluid and/or foam then flows down into the slots 456 to fall further into the interior of the support structure 402, thereby improving the appearance of the overall system 400. A container may be located under the slots 456 to hold any liquid.

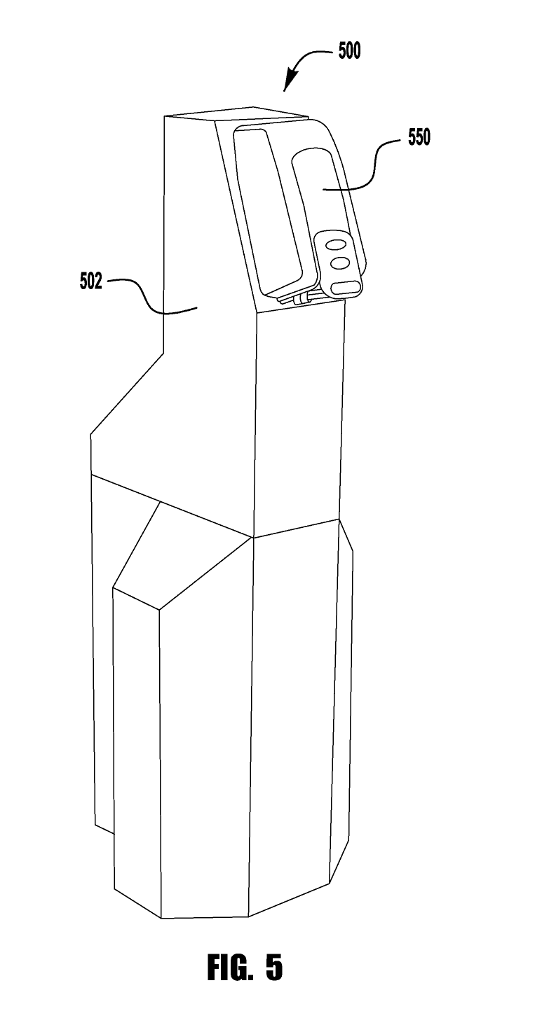

Yet another embodiment of a temporary liquid soap dispensing system 500 is illustrated in FIG. 5. The temporary system 500 has a temporary support structure 502 substantially as already described above, which supports a permanent dispensing system 550. The permanent dispensing system 550 is as known in the prior art described above. The upright stability of the overall system 500 may be enhanced by disposing the permanent dispensing system 550 at a backward-facing angle on the temporary support structure 502, as shown in FIG. 5. Also, in order to support the weight of the permanent system 550, additional supporting elements (not shown) such as brackets may be used to mount the system 550 on the support structure 502.

A method for providing several temporary dispenser systems in the event of an emergency situation is also provided. This method may be used in connection with any one of the particular temporary dispenser systems 100, 400 or 500 disclosed herein, or other such systems. Thus, the method comprises gathering multiple emergency response kits together and storing them in anticipation of an emergency situation arising. Each one of the emergency response kits includes one or more support structure elements in an unassembled condition, or knocked down state, in combination with an initial liquid container filled with a supply of liquid soap or sanitizer. Storing the support structure elements in an unassembled condition reduces the space taken up by the support structure elements, and therefore decreases the cost of storage. When an emergency occurs, several emergency response kits may then be quickly shipped to the location of the emergency, to be assembled and deployed for use.

Another exemplary methodology of providing a temporary support structure to a user includes cutting a flat panel into a desired shape and creating predetermined fold lines in the cut flat panel. In some embodiments, cutting the flat panel into a desired shape includes cutting the flat panel so that it will form a holder for holding a refill unit. In addition, in some embodiments, cutting the flat panel into a desired shape includes cutting the flat panel so that it will form a base for supporting the temporary support structure on a floor. Further in some embodiments, cutting the flat panel into a desired shape includes cutting the flat panel so that it will form a tower between the base and the holder. Still yet, in some embodiments, cutting a flat panel into a desired shape includes cutting one or more additional flat panels that may be secured to the first flat panel. Further, in some embodiments, cutting a flat panel into a desired shape includes cutting a single flat panel to form the desired shape. In some cases, the holder is part of the tower. The exemplary methodology also includes providing instructions for a user to fold the cut flat panel to form a temporary support structure.

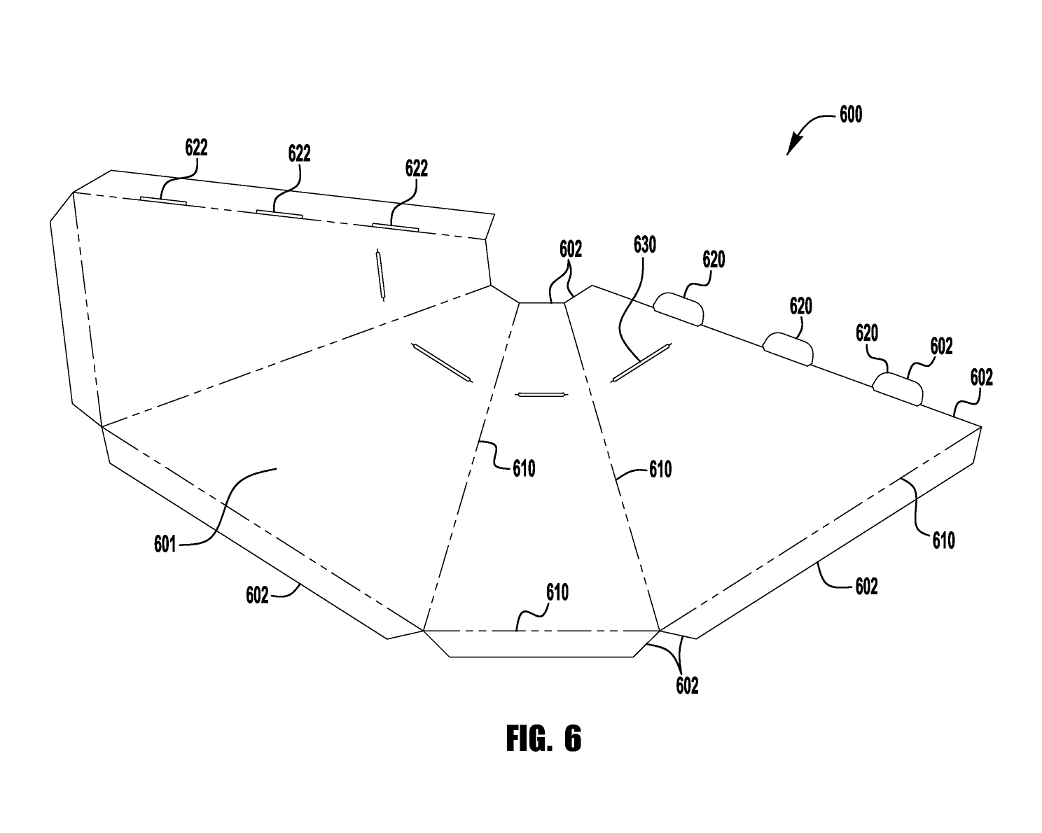

FIG. 6 illustrates an exemplary view of a base 600 in a knocked-down state for a temporary soap or sanitizer dispensing system. As illustrated in FIG. 6, base 600 is formed in a flat stock 601, such as corrugated cardboard and has a plurality of cut lines 602 that form the overall shape of the base 600 and cut-outs in the base 600. Some of the cut lines 602 form locking tabs 620. For purposes of clarity, not all of the “cut lines” and “fold lines” are specifically called out. The solid lines are typically cut lines and the dashed lines are typically fold lines.

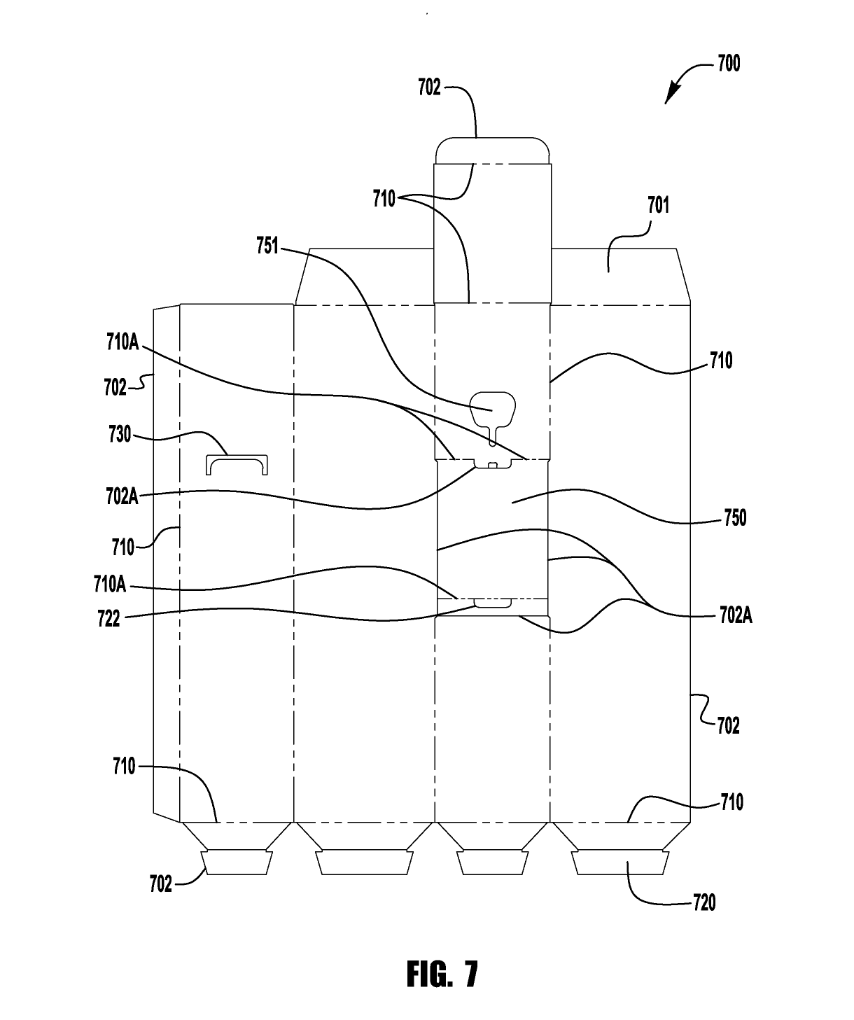

In addition, base 600 includes a plurality of predetermined fold lines 610 and a plurality of slots 622 for receiving locking tabs 620 when the cut out flat stock 601 is folded to form base 600. Base 600 also includes a plurality of slots 630 cut out of the base 600 for receiving locking tabs 720 (FIG. 7) of tower 700.

FIG. 7 illustrates an exemplary view of a tower 700 in a knocked-down state for a temporary soap or sanitizer dispensing system. As illustrated in FIG. 7, tower 700 is formed in a flat stock 701, such as corrugated cardboard and has a plurality of cut lines 702 that form the overall shape of the tower 700 and cutouts in the tower 700. Some of the cut lines 702 form locking tabs 720 for joining to the plurality of slots 630 cut out of base 600. Tower 700 includes opening 750 for receiving insert 800, a cut-out 751 for receiving the pump and outlet nozzle of a refill unit (not shown) and a cut-out 730. Cut-out 750 is formed by cutting cut lines 702A and folding long fold lines 710A so that locking tab 722 may be inserted into a cut-out 730 to form a base of the holder for supporting a refill unit.

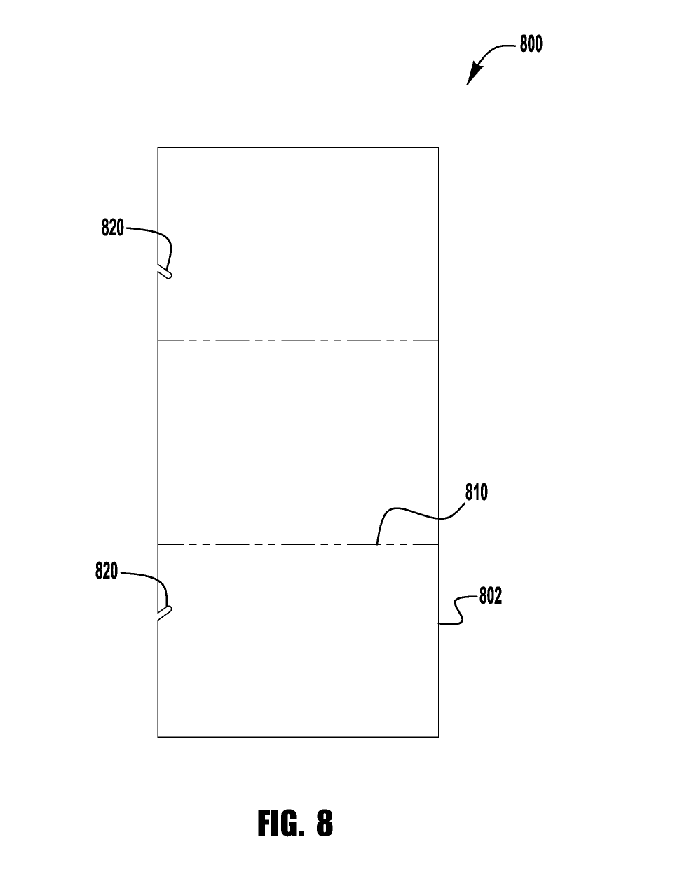

FIG. 8 illustrates an exemplary view of inserts 800 for the tower 700 in a knocked-down state for a temporary soap or sanitizer dispensing system. Insert 800 includes cut lines 802 that form the overall shape of the insert, fold lines 810 and notches 820. In some embodiments, two inserts 800 are used. The first insert is placed at an angle in opening 750 and is secured to tower 700 with notches 820 engaging the front of tower 700. A second insert 800 is inserted in the top of a dispenser system to keep the refill unit pushed forward in the top portion of the tower.

While the present invention has been illustrated by the description of embodiments thereof and while the embodiments have been described in considerable detail, it is not the intention of the applicanta to restrict or in any way limit the scope of the appended claims to such detail. Additional advantages and modifications will readily appear to those skilled in the art. Therefore, the invention, in its broader aspects, is not limited to the specific details, the representative apparatus and illustrative examples shown and described. Accordingly, departures may be made from such details without departing from the spirit or scope of the applicants' general inventive concept.

We claim:

1. A temporary support structure for a dispensing system comprising:
one or more flat panels which form a temporary support structure by being folded and/or attached to one another;
the temporary support structure having,
a base for supporting the temporary structure in an upright position;
a holder for receiving a removable refill unit that holds a supply of liquid to be dispensed by the system; and
an upright section extending from the base to the holder.

2. The temporary support structure of claim 1 wherein the temporary support structure is made from one or more materials selected from a group consisting of craft board, cardboard and plastic.

3. The temporary support structure of claim 1 further comprising a refill unit.

4. The temporary support structure of claim 1 wherein the temporary support structure comprises at least two different flat panels, and the two flat panels may be folded and attached together.

5. The temporary support structure of claim 4 wherein the two flat panels are attached together with a mating tab-and-slot interaction.

6. The temporary support structure of claim 3 wherein the refill unit comprises one of a flexible bag structure, a rigid box structure or a rigid collapsible box structure.

7. The temporary support structure of claim 1 wherein the base flares outward on two or more sides of the temporary support structure.

8. The temporary support structure of claim 1 further comprising a drip catcher.

9. The temporary support structure of claim 1 further comprising at least one ballast element disposed within or around the base of the support structure to improve the stability of the system.

10. The temporary support structure of claim 9 wherein the ballast element includes at least one refill unit.

11. The temporary support structure of claim 1 wherein the support structure comprises an aperture to receive a pump and outlet as the refill unit is inserted into the support structure.

12. The temporary support structure of claim 11 wherein the support structure further comprises an aperture for an outlet.

13. A temporary support structure for a fluid dispensing mechanism comprising:
a first flat panel in a flattened condition, the first flat panel having cut lines and fold lines, so that the first flat panel may be folded into the shape of a base; and
a second flat panel in a flattened condition, the second flat panel having cut lines and fold lines, so that the second flat panel may be folded into a shape of a tower and secured to the base, wherein the tower includes a holder for holding a fluid dispense mechanism to dispense fluid onto a object.

14. The temporary support structure of claim 13 wherein at least one of the first and second flat panels further comprises locking tabs and at least one of the first and second flat panel comprises slots for receiving the locking tabs to join the first flat panel to the second flat panel when the first and second flat panels are folded into a base and a tower.

15. The temporary support structure of claim 13 wherein the tower includes a cover for enclosing the top of the temporary support structure.

16. A method of providing a temporary support structure for a fluid dispensing mechanism comprising:
cutting one or more flat panels into desired shapes;
creating predetermined fold lines in the one or more cut flat panels;
wherein cutting the flat panels into desired shapes includes cutting the flat panel so that at least one flat panel will form a holder for holding a refill unit or a dispenser;
cutting the flat panels so that at least one flat panel will form a base for supporting the temporary support structure on a floor; and
cutting the flat panel so that at least one flat panel will form an intermediate portion between the base and the holder.

17. The method of claim 16 further comprising providing refill units to be placed in the holder of the temporary support structure.

18. The method of claim 16 wherein cutting the flat panels into a desired shape includes cutting more than one flat panel to form the desired shape.

19. The method of claim 16 wherein cutting a flat panel into a desired shape includes cutting two or less flat panels to form the desired shapes.

20. The method of claim 16 wherein the flat panel is cardboard.
